(19) United States
(12) Patent Application Publication
(10) Pub. No.: US 2016/0297277 A1
(43) Pub. Date: Oct. 13, 2016

(54) DYNAMIC MOTOR VEHICLE STEERING LINKAGE STABILIZER AND METHODS OF USE

(71) Applicant: Harold Maddox, Eufala, OK (US)

(72) Inventor: Harold Maddox, Eufala, OK (US)

(21) Appl. No.: 14/683,521

(22) Filed: Apr. 10, 2015

(51) Int. Cl. B60G 17/08; B62D 7/22; B60G 21/073; B62D 7/08; B60G 21/02; B60G 21/055

(52) U.S. Cl. CPC B60G 17/08; B60G 21/026; B60G 21/055; B60G 21/073; B62D 7/08; B62D 7/22

(57) ABSTRACT

A dynamic motor vehicle steering linkage stabilizer and methods of use including, in general, a motor vehicle steering system, which includes a stationary point such as an axel, a moveable tie or steering rod to rotate the front wheels for steering, a stabilizer or strut, such as fixed steering control device, and dual sided hydraulic positioning cylinder and, thus, functions to be easy to installed, works integral with the fixed steering control device and motor vehicle steering system, and dynamically resets the straight ahead or center position of the steering system to compensate for side and crosswind forces pushing on the motor vehicle.

### TECHNICAL FIELD

The disclosure relates generally to motor vehicle systems and, more particularly, the disclosure relates to a motor vehicle counter steering systems.

### BACKGROUND

Motor vehicles, especially large motor vehicles, such as RVs, vans, pickup trucks, tractor-trailers and school buses are subject to shock or quick changes from crosswinds, gust, passing tractor-trailers, bumps, ruts, potholes, pavement changes, blowouts and the like (“shock or quick changes”), which may send the motor vehicle out of control.

To control such shock or quick changes in steering motor vehicle steering systems have been equipped with reactionary or fixed steering control device, such as the self-centering shock dampening stabilizer, coupled to the steering system, which automatically and quickly return the steering system back to center or straight after such shock or quick changes in the motor vehicle steering systems enabling an operator to stabilize the motor vehicle steering and hopefully avoid loss of control.

One problem with this approach is that there is no ability to fine tune the fixed steering control device. For example, when the motor vehicle is subject to continuous crosswinds and gust an operator must apply a counter rotational force to the driver's steering wheel to counter the fixed steering control device desired to return the steering system to center or straight ahead when such steering direction would not maintain the motor vehicle within the road lines. Application of the counter rotational force by the operator over time results in operator fatigue.

Therefore, it is readily apparent that there is a recognized unmet need for a dynamic motor vehicle steering linkage stabilizer and methods of use that is easy to install, works integral with fixed steering control device and motor vehicle steering system, and dynamically resets the straight ahead or center position of the steering system to compensate for side and crosswind forces pushing on the motor vehicle.

### BRIEF SUMMARY

Briefly described, in example embodiment, the present apparatus overcomes the above-mentioned disadvantage, and meets the recognized need for a dynamic motor vehicle steering linkage stabilizer and methods of use including, in general, a motor vehicle steering system, which includes a stationary point such as an axel, a moveable tie or steering rod to rotate the front wheels for steering, a stabilizer or strut, such as fixed steering control device, and dual sided hydraulic positioning cylinder and, thus, functions to be easy to installed, works integral with the fixed steering control device and motor vehicle steering system, and dynamically resets the straight ahead or center position of the steering system to compensate for side and crosswind forces pushing on the motor vehicle.

In a preferred exemplary embodiment, a dynamic self-centering stabilizer for a vehicle steering linkage constructed and arranged for connection between a fixed point on the vehicle and a moving element of the steering linkage, the stabilizer includes a self-centering shock dampening stabilizer having a first stabilizer end and a second stabilizer end, the first stabilizer end removably affixed to the moving element of the steering linkage, and a center adjusting hydraulic cylinder having a body, the body includes one or more hydraulic fluid passageways therein, wherein the body is formed having at least one aperture, a hydraulic shaft, the hydraulic shaft having a first shaft end and a second shaft end, wherein the hydraulic shaft includes a piston, the piston positioned on the shaft between the first shaft end and the second shaft end, wherein the piston is slidably positioned between a first piston passageway and second piston passageway of the one or more hydraulic fluid passageways, the first piston passageway and the second piston passageway connected by one or more hydraulic fluid passageways of the one or more hydraulic fluid passageways, the one or more hydraulic fluid passageways includes a flow adjustment device, wherein the second shaft end extends through a shaft aperture of the at least one aperture, wherein the second shaft end is removeably connected to an attachment device, the attachment device is removeably affixed to the moving element of the steering linkage, and the body is removeably affixed to the fixed point on the vehicle.

In still a further exemplary embodiment of the method of dynamic self-centering of a vehicle having a steering linkage constructed and arranged for connection between a fixed point on the vehicle and a moving element of the steering linkage mechanically tied to a steering wheel, the method includes the steps of providing a stabilizer having a self-centering shock dampening stabilizer having a first stabilizer end and a second stabilizer end, the first stabilizer end removably affixed to the moving element of the steering linkage, and a center adjusting hydraulic cylinder having a body, the body includes one or more hydraulic fluid passageways therein, wherein the body is formed having at least one aperture, a hydraulic shaft, the hydraulic shaft having a first shaft end and a second shaft end, wherein the hydraulic shaft includes a piston, the piston positioned on the shaft between the first shaft end and the second shaft end, wherein the piston is slidably positioned between a first piston passageway and second piston passageway of the one or more hydraulic fluid passageways, the first piston passageway and the second piston passageway connected by one or more hydraulic fluid passageways of the one or more hydraulic fluid passageways, the one or more hydraulic fluid passageways includes a flow adjustment device, wherein the second shaft end extends through a shaft aperture of the at least one aperture, wherein the second shaft end is removeably connected to an attachment device, the attachment device is removeably affixed to the moving element of the steering linkage, and the body is removeably affixed to the fixed point on the vehicle, generating a counter responsive force by the self-centering shock dampening stabilizer against a continuous external force being applied to the vehicle, and relieving a counter rotational steering force on the steering wheel connected to the steering linkage of the vehicle.

Accordingly, a feature of the dynamic motor vehicle steering linkage stabilizer and methods of use is the ability to dynamically resets the straight ahead or center position of the steering system to compensate for side and crosswind forces pushing on the motor vehicle.

Another feature of the dynamic motor vehicle steering linkage stabilizer and methods of use is the ability to integrate the dynamic motor vehicle steering linkage stabilizer with the fixed steering control device.

Still another feature of the dynamic motor vehicle steering linkage stabilizer and methods of use is that it is easy to install with a fixed steering control device.

Yet another feature of the dynamic motor vehicle steering linkage stabilizer and methods of use is the ability to provide a safe, efficient and economical dynamic steering mechanism stabilizer system for motor vehicles.

Yet another feature of the dynamic motor vehicle steering linkage stabilizer and methods of use is the ability to provide a dynamic steering control device that is of a rugged, high strength construction, dependable and safe in use, may be readily manufactured and assembled, and may be constructed from economically produced components.

Yet another feature of the dynamic motor vehicle steering linkage stabilizer and methods of use is the ability to provide a safe, efficient and economical steering mechanism stabilizer in motor vehicles.

Yet another feature of the dynamic motor vehicle steering linkage stabilizer and methods of use is the ability to stabilize the steering linkage while enabling dynamic biasing toward a positive center or straight-ahead condition.

These and other features of the dynamic motor vehicle steering linkage stabilizer and methods of use will become more apparent to one skilled in the art from the following Detailed Description of the Embodiments and Claims when read in light of the accompanying drawing Figures.

### BRIEF DESCRIPTION OF THE DRAWINGS

The present dynamic motor vehicle steering linkage stabilizer and methods of use will be better understood by reading the Detailed Description of the embodiments with reference to the accompanying drawing figures, in which like reference numerals denote similar structure and refer to like elements throughout, and in which:

FIG. 1 is a top view of a prior art motor vehicle steering system with a fixed self-centering shock dampening stabilizer, shown installed on a motor vehicle steering system;

FIG. 2 is a cross-sectional view of an exemplary embodiment of center adjusting hydraulic cylinder; and

FIG. 3 is a top system view of center adjusting hydraulic cylinder of FIG. 2, shown integrated thereto fixed self-centering shock dampening stabilizer shown in FIG. 1.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

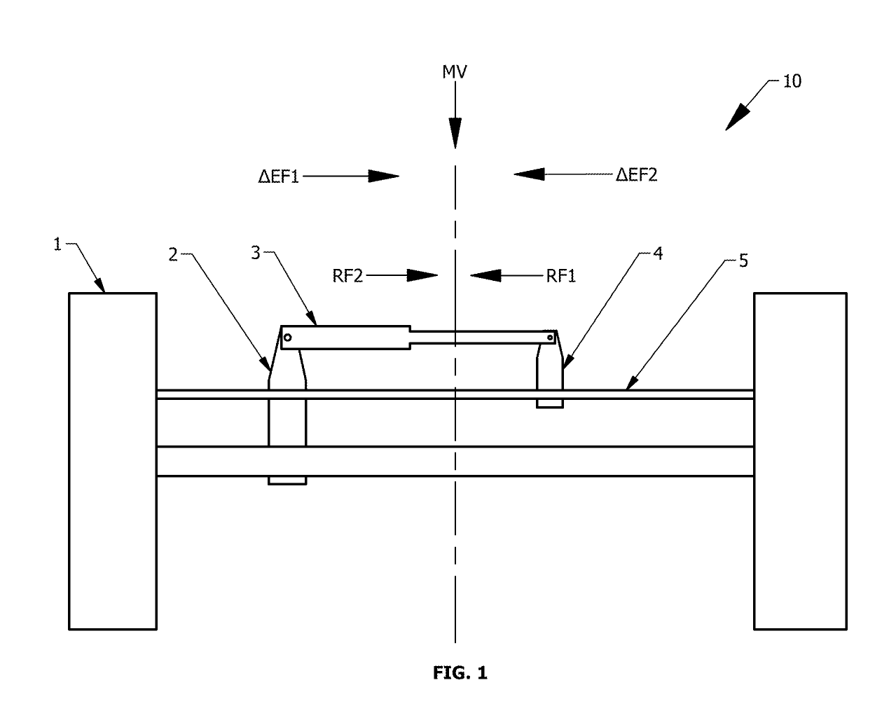

In describing the exemplary embodiments of the present disclosure, as illustrated in FIGS. 1-3 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1 there is illustrated a sub assembly of a motor vehicle MV having steering system 10 and includes steering or turnable tires 1, axel 6 or other stationary component, vehicle frame, or fixed point of motor vehicle MV and steering linkage, such as tie rod 5 or other component tied to the movement of vehicle steerable wheels, such as turnable tires 1 of steering system 10. The described steering linkage is largely conventional and its construction may vary somewhat in different models and types of motor vehicle MV. Preferably, self-centering shock dampening stabilizer 3 is positioned between and removeably connected thereto fixed point 2 affixed to axel 6 of motor vehicle MV and moving point 4 affixed to steering linkage, such as tie rod 5 which interconnects the vehicle steerable wheels and steering system 10 and on up to steering wheel of motor vehicle operator.

It is known that self-centering shock dampening stabilizer 3 dampens shock or quick changes, such as deviations from center line CL, generated by shock or quick changing external force ΔEf on turnable tires 1 and motor vehicle MV, which otherwise tend to be transmitted back through the linkage to the steering wheel, and, thus self-centering shock dampening stabilizer 3 tends to return or bias turnable tires 1 and motor vehicle MV toward a positive center or straight-ahead position, such as center line CL in reaction to changing external force ΔEf on turnable tires 1 and motor vehicle MV.

For example, shock or quick changing external force ΔEf1 on turnable tires 1 and motor vehicle MV results in a counter responsive force Rf1 from self-centering shock dampening stabilizer 3 on steering linkage, such as tie rod 5, which tends to return or bias turnable tires 1 and motor vehicle MV back toward center line CL (self-centering) in reaction to changing external force ΔEf1 on turnable tires 1 and motor vehicle MV. Moreover, shock or quick changing external force ΔEf2 on turnable tires 1 and motor vehicle MV results in a counter responsive force Rf2 from self-centering shock dampening stabilizer 3 on steering linkage, such as tie rod 5, which tends to return or bias turnable tires 1 and motor vehicle MV back toward center line CL (self-centering) in reaction to changing external force ΔEf2 on turnable tires 1 and motor vehicle MV.

Additionally, in accordance with a major objective of the prior art, self-centering shock dampening stabilizer 3 prevents a variety of external forces from being transmitted through tie rod 5 to steering wheel 8 by dampening and absorbing the shocks in such forces.

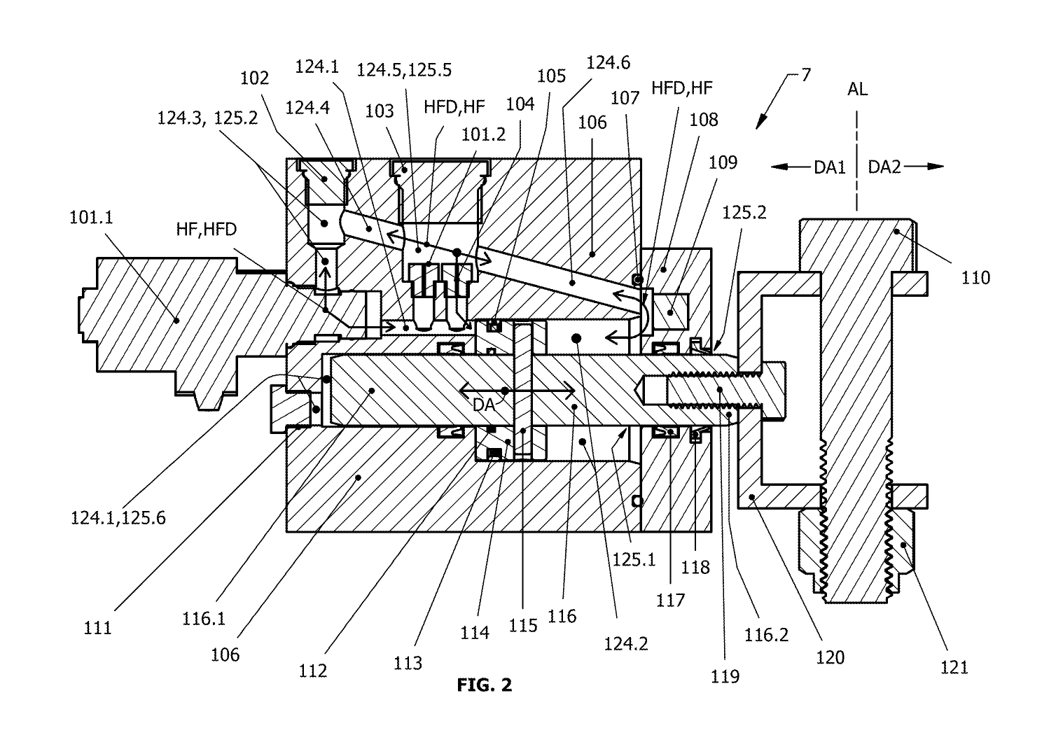

Referring now to FIG. 2 by way of example, and not limitation, therein is illustrated an example embodiment of center adjusting hydraulic cylinder 7. Preferably center adjusting hydraulic cylinder 7 includes hydraulic body 106 having one or more holes or openings, such as one or more access apertures 125 and one or more internal conduits, fluid passageways, such as hydraulic fluid passageways 124, hydraulic shaft 116 positioned therein passage ways, such as first piston passageway 124.1 and second piston passageway 124.2, wherein hydraulic shaft 116 having first shaft end 116.1 and second shaft end 116.2 positioned therein first piston passageway 124.1 and second piston passageway 124.2, respectively, wherein first piston passageway 124.1 and second piston passageway 124.2 are divided chambers by a plunger, such as piston 114, and wherein second shaft end 116.2 protrudes there through first aperture 125.1 of hydraulic body 106 and through second aperture 126.2 of faceplate 108 configured to be removeably affixed to hydraulic body 106. Preferably piston 114 may be removeably affixed to hydraulic shaft 116 by a piston attachment device, such as c-ring or pin 115. Moreover, attachment device, such as clevis 120 may be removeably affixed thereto second shaft end 116.2 via for example by first bolt 119. Clevis 120 may include a coupling device, such as second bolt 110 and nut 121 as a flexible coupler device configured to removably affix clevis 120 thereto second end 3.2 of center adjusting hydraulic cylinder 7. Moreover, body 106 may be configured to be removably affix thereto first end 2.1 of fixed point 2 affixed to affixed to axel 6 of motor vehicle MV.

In use, center adjusting hydraulic cylinder 7 preferably includes one or more hydraulic fluid passageways 124, such as 124.3, 124.4, 124.5, 124.6 connecting thereto first piston passageway 124.1 and second piston passageway 124.2 wherein hydraulic fluid HF may traverse hydraulic fluid passageways 124, as shown by hydraulic fluid direction HFD arrows and indicators, and, thus hydraulic fluid passageways 124, first piston passageway 124.1 and second piston passageway 124.2 are configured to enable piston 114 and hydraulic shaft 116 to move laterally, as shown by delayed adjustment DA. It is recognized herein that body 106 may include one or more apertures, such as access apertures 125.2, 125.3, 125.5 and 125.6 as access points to hydraulic fluid passageways 124, and apertures 125.3, 125.5 and 125.6 may be capped or sealed by plugs, such as plugs 102, 103 and plug 111, respectively. Furthermore, all moving parts, such as piston 114, hydraulic shaft 116, and face plate 108 may require seal devices, such as seals 105, 117, wiper 118, O-rings, such as first O-ring 107, and second O-ring 112, square seal ring 113, and rubber 109 to seal in hydraulic fluid HF.

Moreover, hydraulic fluid passageways 124 may include one or more flow adjustment devices 101, such as electromagnetic or electrically controlled valve, such as solenoid 101.1 or an adjustable needle or orifice valve 101.2 which may include adjustable orifice 104. Preferably one or more flow adjustment devices 101 are configured to enable adjustment of the flow rate of hydraulic fluid HF there through hydraulic fluid passageways 124, and thus delay the response time or delay adjustment of center adjusting hydraulic cylinder 7 after self-centering shock dampening stabilizer 3 has responded via delayed adjustment DA of hydraulic shaft 116 of center adjusting hydraulic cylinder 7. Preferably one or more flow adjustment devices 101 may be adjusted to increase or decrease flow rate of hydraulic fluid HF therethrough hydraulic fluid passageways 124, and thus increase or decrease the response time-delayed adjustment DA, such as first delayed adjustment DA1 and opposite second delayed adjustment DA2 of center adjusting hydraulic cylinder 7.

When an external force tends to drive hydraulic shaft 116 to the left into or retracting further into hydraulic body 106, one or more flow adjustment devices 101 enable delayed retraction of hydraulic shaft 116, such as first delayed adjustment DA1. When an external force tends to drive hydraulic shaft 116 to the right out of, extension, or extending further from hydraulic body 106, one or more flow adjustment devices 101 enable delayed extension of hydraulic shaft 116, such as second delayed adjustment DA2.

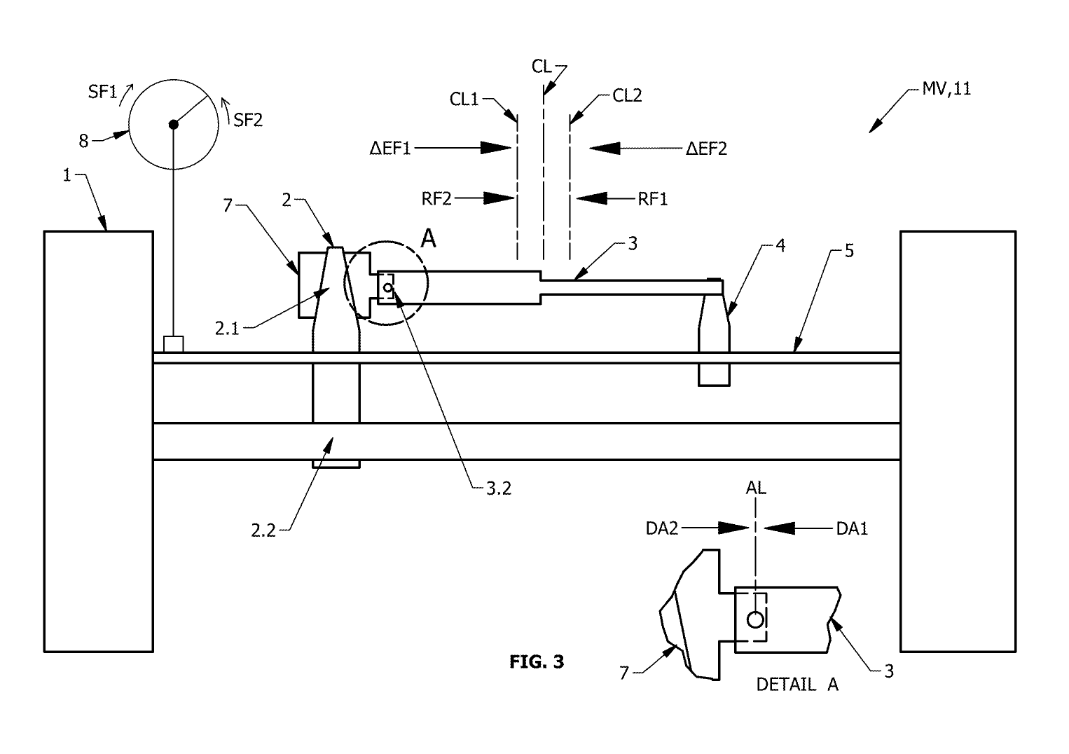

Referring now to FIG. 3, by way of example, and not limitation, there is illustrated steering system 10 having self-centering shock dampening stabilizer 3 with center adjusting hydraulic cylinder 7 of FIG. 2, shown integrated there together as dynamic self-centering shock dampening stabilizer steering system 11. In use, continuous external force cEf on turnable tires 1 and motor vehicle MV places a similar continuous external force cEf on self-centering shock dampening stabilizer 3, and thus, center adjusting hydraulic cylinder 7 is preferably configured to enable time delayed adjustment DA of center adjusting hydraulic cylinder 7 preferably repositioning self-centering shock dampening stabilizer 3 in reaction to continuous external force cEf on turnable tires 1 and motor vehicle MV.

For example, continuous external force cEf1 on turnable tires 1 and motor vehicle MV results in a counter responsive force Rf1 from self-centering shock dampening stabilizer 3 on steering linkage, such as tie rod 5, resulting in a bias of turnable tires 1 and motor vehicle MV toward center line CL1 causing an operator of steering wheel 8 of motor vehicle MV to apply a continuous counter rotational steering force Sf1 against counter responsive force Rf1 to return motor vehicle MV back toward center line CL. It is recognized herein that application of counter rotational steering force Sf1 over time results in motor vehicle operator fatigue. It is recognized herein that center adjusting hydraulic cylinder 7 is preferably configured to relieve rotational steering force Sf1 caused by counter responsive force Rf1 via repositioning of center adjusting hydraulic cylinder 7 by delayed adjustment DA1 (shown in FIG. 2—hydraulics enable hydraulic fluid to bleed in the direction of DA1 and hydraulic shaft 116 is drawn (retracted) into body 106) and thus return motor vehicle MV to center line CL.

Alternatively, continuous external force cEf2 on turnable tires 1 and motor vehicle MV results in counter responsive force Rf2 from self-centering shock dampening stabilizer 3 on steering linkage, such as tie rod 5, resulting in a bias of turnable tires 1 and motor vehicle MV toward center line CL2 causing an operator of steering wheel 8 of motor vehicle MV to apply a continuous counter rotational steering force Sf2 against counter responsive force Rf2 to return motor vehicle MV back toward center line CL. It is recognized herein that center adjusting hydraulic cylinder 7 is preferably configured to relieve rotational steering force Sf2 caused by counter responsive force Rf2 via repositioning of center adjusting hydraulic cylinder 7 by delayed adjustment DA2 (shown in FIG. 2—hydraulics enable hydraulic fluid to bleed in the direction of DA2 and hydraulic shaft 116 is extended from body 106) and thus return motor vehicle MV to center line CL.

It is recognized herein that self-centering shock dampening stabilizer 3 is preferably configured to react to shock or quick changing external force ΔEf on turnable tires 1 and motor vehicle MV, which enables quick return or bias of turnable tires 1 and motor vehicle MV back toward center line CL (self-centering) in reaction to quick changing external force ΔEf on turnable tires 1 and motor vehicle MV, whereas the addition of delayed center adjusting hydraulic cylinder 7 thereto self-centering shock dampening stabilizer 3 preferably enables delayed center adjusting of self-centering shock dampening stabilizer 3 to relieve rotational steering force Sf caused by counter responsive force Rf by repositioning of center adjusting hydraulic cylinder 7 by delayed adjustment DA (hydraulics enable hydraulic fluid to bleed in the direction of DA1/DA2 and hydraulic shaft 116 is retracted/extended from body 106) to reposition self-centering shock dampening stabilizer 3.

It may be seen that the described center adjusting hydraulic cylinder 7 arrangement renders self-centering shock dampening stabilizer 3 positive self-centering when biased by continuous external force cEf2 on turnable tires 1 and motor vehicle MV.

It is recognized herein that first delayed adjustment DA1 and second delayed adjustment DA2 reposition self-centering shock dampening stabilizer 3 in direction to offset continuous external force cEf. Center adjusting hydraulic cylinder 7 preferably repositions self-centering shock dampening stabilizer 3 to offset continuous external force cEf on self-centering shock dampening stabilizer 3 in either direction (one direction first delayed adjustment DA1 or the opposite direction second delayed adjustment DA2).

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A dynamic self-centering stabilizer for a vehicle steering linkage constructed and arranged for connection between a fixed point on a vehicle and a moving element of the vehicle steering linkage, said dynamic self-centering stabilizer comprising:
a self-centering shock dampening stabilizer having a first stabilizer end and a second stabilizer end, said first stabilizer end removably affixed to the moving element of the steering linkage; and
a center adjusting hydraulic cylinder having a body, said body includes one or more hydraulic passageways therein, wherein said body is formed having at least one aperture, a hydraulic shaft, said hydraulic shaft having a first shaft end and a second shaft end, wherein said hydraulic shaft includes a piston, said piston positioned on said shaft between said first shaft end and said second shaft end, wherein said piston is slidably positioned between a first piston passageway and second piston passageway of said one or more hydraulic fluid passageways, said first piston passageway and said second piston passageway connected by said one or more hydraulic fluid passageways of said one or more hydraulic fluid passageways, said one or more hydraulic fluid passageways includes a flow adjustment device, wherein said second shaft end extends through a shaft aperture of said at least one aperture, wherein said second shaft end is removeably connected to an attachment device, said attachment device is removeably affixed to the moving element of the steering linkage, and said body is removeably affixed to the fixed point on the vehicle.

2. The dynamic self-centering stabilizer of claim 1, further comprises a faceplate, said faceplate removably affixed to said hydraulic body.

3. The dynamic self-centering stabilizer of claim 2, wherein said faceplate further comprises a second aperture therein of said at least one aperture, wherein said second shaft end extends through said second aperture.

4. The dynamic self-centering stabilizer of claim 1, wherein said piston is removably affixed thereto said hydraulic shaft by a pin.

5. The dynamic self-centering stabilizer of claim 1, wherein said attachment device further comprises a clevis.

6. The dynamic self-centering stabilizer of claim 5, further comprises a coupling device configured to removeably affix said clevis to the moving element of the steering linkage.

7. The dynamic self-centering stabilizer of claim 1, wherein said at least one aperture includes one or more access apertures connected thereto said one or more hydraulic fluid passageways.

8. The dynamic self-centering stabilizer of claim 7, wherein said one or more access apertures further comprises a plug to seal one of said one or more access apertures.

9. The dynamic self-centering stabilizer of claim 8, wherein said one or more access apertures is configured to position said flow adjustment device therein said one or more hydraulic fluid passageways.

10. The dynamic self-centering stabilizer of claim 1, wherein said flow adjustment device is configured to delay adjustment of said center adjusting hydraulic cylinder.

11. The dynamic self-centering stabilizer of claim 1, wherein said flow adjustment device further comprises an adjustable orifice.

12. The dynamic self-centering stabilizer of claim 1, wherein said flow adjustment device further comprises a solenoid.

13. The dynamic self-centering stabilizer of claim 1, wherein said flow adjustment device is configured to delay retraction of said hydraulic shaft.

14. The dynamic self-centering stabilizer of claim 1, wherein said flow adjustment device is configured to delay extension of said hydraulic shaft.

15. The dynamic self-centering stabilizer of claim 2, wherein said faceplate further comprises a first o-ring configured to seal said faceplate to said body.

16. The dynamic self-centering stabilizer of claim 3, wherein said faceplate further comprises a second o-ring configured to seal said second shaft end extending through said second aperture therein said faceplate.

17. The dynamic self-centering stabilizer of claim 1, wherein said piston further comprises a seal ring configured to seal between said first piston passageway and said second piston passageway of said one or more hydraulic fluid passageways.

18. A method of dynamic self-centering of a vehicle having a steering linkage constructed and arranged for connection between a fixed point on the vehicle and a moving element of the steering linkage mechanically tied to a steering wheel, said method comprising the steps of:
providing a stabilizer having a self-centering shock dampening stabilizer having a first stabilizer end and a second stabilizer end, said first stabilizer end removably affixed to the moving element of the steering linkage, and a center adjusting hydraulic cylinder having a body, said body includes one or more hydraulic fluid passageways therein, wherein said body is formed having at least one aperture, a hydraulic shaft, said hydraulic shaft having a first shaft end and a second shaft end, wherein said hydraulic shaft includes a piston, said piston positioned on said shaft between said first shaft end and said second shaft end, wherein said piston is slidably positioned between a first piston passageway and second piston passageway of said one or more hydraulic fluid passageways, said first piston passageway and said second piston passageway connected by said one or more hydraulic fluid passageways of said one or more hydraulic fluid passageways, said one or more hydraulic fluid passageways includes a flow adjustment device, wherein said second shaft end extends through a shaft aperture of said at least one aperture, wherein said second shaft end is removeably connected to an attachment device, said attachment device is removeably affixed to the moving element of the steering linkage, and said body is removeably affixed to the fixed point on the vehicle;
generating a counter responsive force by said self-centering shock dampening stabilizer against a continuous external force being applied to the vehicle; and
relieving a counter rotational steering force on the steering wheel connected to the steering linkage of the vehicle.

19. The method of claim 18, further comprising the step of repositioning of said self-centering shock dampening stabilizer by delayed adjustment of said hydraulic shaft.

20. The method of claim 19, further comprising the step of retracting said hydraulic shaft to reposition said self-centering shock dampening stabilizer in a first delayed adjustment.

21. The method of claim 19, further comprising the step of extending said hydraulic shaft to reposition said self-centering shock dampening stabilizer in a second delayed adjustment.
